(19) United States
(12) Patent Application Publication
(10) Pub. No.: US 2009/0021437 A1
(43) Pub. Date: Jan. 22, 2009

(54) CENTER PANEL MOVABLE THREE-COLUMN ARRAY ANTENNA FOR WIRELESS NETWORK

(76) Inventor: Senglee Foo, Irvine, CA (US)

Correspondence Address: MYERS DAWES ANDRAS & SHERMAN, LLP, 19900 MACARTHUR BLVD., SUITE 1150, IRVINE, CA, 92612, US

(21) Appl. No.: 12/175,425

(22) Filed: Jul. 17, 2008

Related U.S. Application Data
(60) Provisional application No. 60/961,483, filed on Jul. 20, 2007.

(51) Int. Cl. H01Q 3/12; H01Q 21/00

(52) U.S. Cl. 343/761; 343/836

(57) ABSTRACT

An azimuth beamwidth variable antenna array for a wireless network system is disclosed. A multi-column antenna array architecture is employed having a mechanical azimuth beamwidth adjustment capability. The array comprises a plurality of driven radiating elements that are spatially arranged having movable Aperture Coupling Patch (ACP) radiating—receiving elements so as to provide a controlled variation of the antenna array's azimuth radiation pattern.

### RELATED APPLICATION INFORMATION

The present application claims priority under 35 USC section 119(e) to U.S. provisional patent application Ser. No. 60/961,483 filed Jul. 20, 2007, the disclosure of which is incorporated herein by reference in its entirety.

### BACKGROUND OF THE INVENTION

1. Field of the Invention

The present invention relates in general to communication systems and components. More particularly, the present invention is directed to antenna arrays for use in wireless networks.

2. Description of the Prior Art and Related Background Information

Modern wireless antenna implementations generally include a plurality of radiating elements that may be arranged over a ground plane defining a radiated (and received) signal beam width and azimuth scan angle. Azimuth antenna beam width can be advantageously modified by varying amplitude and phase of an RF signal applied to respective radiating elements. Azimuth antenna beam width has been conventionally defined by Half Power Beam Width (HPBW) of the azimuth beam relative to a bore sight of such antenna array. In such antenna array structure radiating element positioning is critical to the overall beamwidth control as such antenna systems rely on accuracy of amplitude and phase angle of the RF signal supplied to each radiating element. This places severe constraints on the tolerance and accuracy of a mechanical phase shifter to provide the required signal division between various radiating elements over various azimuth beam width settings.

Real world applications often call for an antenna array with beam down tilt and azimuth beam width control that may incorporate a plurality of mechanical phase shifters to achieve such functionality. Such highly functional antenna arrays are typically retrofitted in place of simpler, lighter and less functional antenna arrays while weight and wind loading of the newly installed antenna array can not be significantly increased. Accuracy of a mechanical phase shifter generally depends on its construction materials. Generally, highly accurate mechanical phase shifter implementations require substantial amounts of relatively expensive dielectric materials and rigid mechanical support. Such construction techniques result in additional size, weight, and electrical circuit losses as well as being relatively expensive to manufacture. Additionally, mechanical phase shifter configurations that have been developed utilizing lower cost materials may fail to provide adequate passive intermodulation suppression under high power RF signal levels.

Consequently, there is a need to provide a simpler method to adjust antenna beam width control while retaining down tilt beam capability.

### SUMMARY OF THE INVENTION

In a first aspect the present invention provides an antenna for a wireless network comprising first, second and third reflectors each having one or more radiators coupled thereto. The second reflector is configured adjacent to and between the first and third reflectors. The second reflector is generally planar and movable relative to the first and third reflectors in a direction generally perpendicular to the planar surface of the second reflector.

In one preferred embodiment the first and third reflectors may be fixed. The first and third reflectors are preferably generally planar and configured with their planar surfaces oriented at different angles relative to that of the second reflector. The second reflector is preferably movable from a first configuration where the surface thereof is generally contiguous with the adjacent surfaces of the first and third reflectors to a second configuration where the surface thereof is above the adjacent surfaces of the first and third reflectors. The second reflector is also preferably movable to a third configuration wherein the surface thereof is configured below the adjacent surfaces of the first and third reflectors. The second reflector has a generally planar surface which may be defined by a Y-axis and an X-axis parallel to the plane of the reflector surface and a Z-axis extending out of the plane of the reflector, and the second reflector is movable in the Z direction. The first and second reflectors and second and third reflectors have adjacent edge portions and in the first configuration respective adjacent edge portions are aligned. The second reflector is offset in the Z direction from adjacent edge portions of the first and third reflectors by a first positive distance in the second configuration and by a second negative distance in the third configuration. For example, the first distance may be about +25 mm and the second distance about −20 mm. The antenna preferably further comprises an actuator coupled to the second reflector. The radiators coupled to the first and third reflectors may be offset in the Y direction from the radiators coupled to the second reflector.

In another aspect, the present invention provides a mechanically variable beam width antenna. The antenna comprises a reflector structure having plural reflector panels with respective generally planar panel surfaces oriented in different directions, the plural reflector panels including a center panel and first and second outer panels. A first plurality of radiators are coupled to the first outer panel and configured in a first column, a second plurality of radiators are coupled to the second outer panel and configured in a second column, and a third plurality of radiators are coupled to the center panel and configured in a third column. The antenna includes at least one actuator coupled to the center panel, wherein the center reflector panel is movable relative to the other panels from a first configuration wherein adjacent edge portions of the panel surfaces are contiguous to a second configuration where the center panel surface is spaced above or below the adjacent edge portions of the outer panels.

In a preferred embodiment the antenna further comprises a multipurpose port coupled to the at least one actuator to provide beam width control signals to the antenna. The antenna may also further comprise a signal combining-dividing network for providing RF signals to the first, second and third plurality of radiators wherein the signal combining-dividing network includes a phase shifting network for controlling elevation beam tilt by controlling relative phase of the RF signals applied to the radiators. The first, second and third plurality of radiators are preferably coupled to separate phase shifting networks in groups. For example, the radiators may be coupled to separate phase shifting networks in plural groups of six radiators, each group corresponding to two radiators for each reflector panel. The first and second plurality of radiators are preferably configured in rows aligned perpendicularly to the columns and the third plurality of radiators are offset from the rows of the first and second plurality of radiators. The radiators may comprise aperture coupling patch radiating elements.

In another aspect, the present invention provides a method of adjusting signal beam width in a wireless antenna having a plurality of radiators configured on at least three separate reflector panels including two outer panels and a center panel, wherein at least the center panel is movable in a direction generally perpendicular to a plane of the reflector panel. The method comprises providing the reflector panels in a first configuration where adjacent panel edge portions are aligned to provide a first signal beam width. The method further comprises moving the center panel in a direction generally perpendicular to the surface of the panel to a second configuration wherein the center panel is spaced apart in a direction generally perpendicular to the panel surface from the adjacent panel edge portions of the outer panels to provide a second signal beam width.

In a preferred embodiment of the method the outer panels are fixed. The method preferably further comprises providing at least one beam width control signal for remotely controlling the position setting of the center panel. The method may further comprise providing variable beam tilt by controlling the phase of the RF signals applied to the radiators through a remotely controllable phase shifting network. In a preferred embodiment the network is coupled to separate groups of radiators. In a preferred embodiment the outer panels are configured with panel surfaces oriented at an angle relative to the center panel. Preferably plural radiators are configured on each reflector panel.

Further features and aspects of the invention will be appreciated from the following detailed description of the invention.

### BRIEF DESCRIPTION OF THE DRAWINGS

FIG. 1 is a front view of a triple column antenna array in accordance with a preferred embodiment of the present invention.

FIG. 1A is a front view of the triple column antenna array showing only respective ground planes (radiating elements are not shown for clarity).

FIG. 2 is a cross section along line A-A of FIG. 1 perpendicular to the Y-axis, vertical view from the bottom up. The illustrated example of the triple column antenna array is configured to 41 degrees azimuth beamwidth setting; center column displacement D=0 mm.

FIG. 2A is a cross section along line A-A of FIG. 1 perpendicular to the Y-axis, vertical view from the bottom up in another configuration. The illustrated example of the triple column antenna array is configured to 105 degrees azimuth beamwidth setting; center column displacement D=+25 mm.

FIG. 2B is a cross section along line A-A of FIG. 1 perpendicular to the Y-axis, vertical view from the bottom up in another configuration. The illustrated example of the triple column antenna array is configured to 33 degrees azimuth beamwidth setting; center column displacement D=−20 mm.

FIG. 3 is a schematic drawing corresponding to the views of FIG. 2 which provides details related to winglet angle φ used for outer ground plane orientation relative to the central movable ground plane.

FIG. 4 provides an isometric view of four inter-spaced radiating elements about datum A-A line of the array of FIG. 1.

FIG. 5 provides a top level RF signal interconnect schematic drawing of antenna main modules.

FIG. 6 provides a detailed RF signal interconnection schematic drawing for a first antenna embodiment.

FIG. 6A provides a detailed port assignment for a three port, frequency compensated combiner-divider network.

FIG. 7 provides a detailed RF signal interconnection schematic drawing for a second antenna embodiment.

FIG. 8 provides azimuth radiation patterns of the antenna array at several center column displacement settings—corresponding to the configurations of FIGS. 2, 2A and 2B.

### DETAILED DESCRIPTION OF THE INVENTION

Reference will be made to the accompanying drawings, which assist in illustrating the various pertinent features of the present invention.

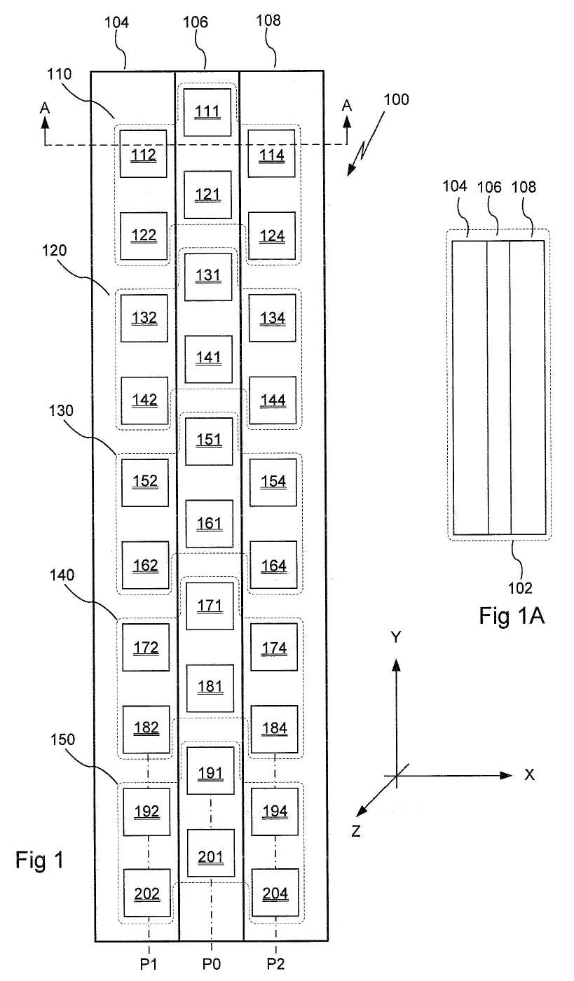

FIG. 1 shows a front view of an antenna array, 100, according to an exemplary implementation, which utilizes three reflector planes 104, 106, 108 and together comprise combined reflector structure 102 of an antenna array 100. All three reflector planes, 104, 106, and 108 are oriented (along the longest dimension) in a vertical orientation (Y-dimension) of the antenna array. Reflectors, 104, 106, and 108 may, for example, consist of electrically conductive plates suitable for use with Radio Frequency (RF) signals—aluminum plate or sheet metal. Although the outer mounted reflectors 104 and 108, planes are shown as featureless rectangles, in actual practice additional features (not shown) may be added to aid reflector performance. Similarly, center mounted reflector plane 106 is preferably rectangular for ease of manufacturing and integration with the outer reflector planes 104 and 108 while all three can be constructed from sheet metal.

The antenna array, 100, comprises a plurality of RF radiators (111, 112, 121, 114-to-204) arranged vertically and preferably proximate to the corresponding vertical alignment axis ( P1, P0, P2) of the corresponding reflector 104, 106 and 108 planes. In the illustrative non-limiting implementation shown in FIG. 1, a plurality of Aperture Coupling Patch (ACP) radiating elements form the antenna array for RF signal transmission and reception. However, it shall be understood that alternative radiating elements, such as taper slot antenna, horn, folded dipole, and others known in the art can be used as well. The foregoing description covers a single polarization antenna and as such can be easily expanded to provide a dual polarization antenna.

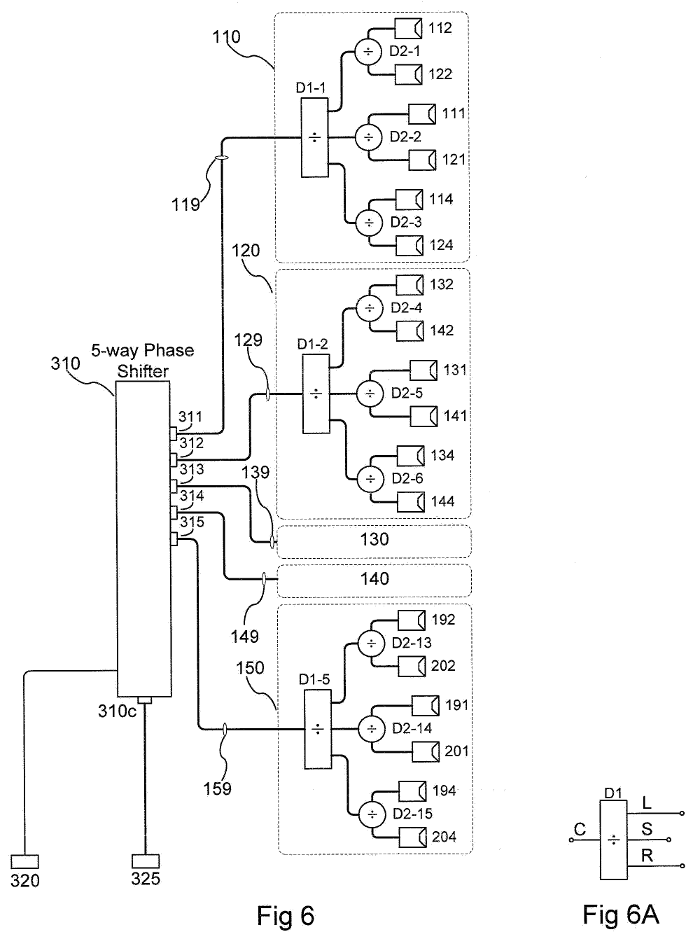

Referring to FIG. 1 and FIG. 6, in the transmit mode RF radiator elements (112, 114, 122, 124, 122, 124-to-202, 204) are fed from a single RF input port 325, through a five way remotely controllable phase shifter 310 which provides remote electric tilt (RET) control for antenna radiation pattern by altering phase angle of the input RF signals among the five output ports (311-315). Remotely controllable down tilt based on remotely controllable signal phase shifting is described in U.S. Pat. No. 5,949,303 assigned to current assignee and incorporated herein by reference. In the current implementation, remotely controllable 5-way phase shifter 310 has a common port 310c which is connected to RF input port 325 and is equipped with corresponding five RF input-output (RF I/O) distribution ports (311-315). The RF I/O distribution ports (311-315) are coupled to five antenna (110, 120, 130, 140, and 150) groups (six-packs) via suitable radio frequency wave guides (119, 129, 139, 149, and 159) such as coaxial cable. Each antenna (110, 120, 130, 140, and 150) group utilizes a “six-pack” of RF radiator elements. Since all networks are linear and passive reciprocal signal flow allows signal combining during signal reception. If RET or mechanical beam tilt are not desired then a simple 5-way signal dividing-combining network can be used instead.

With reference to FIG. 1, by convention, the top most “six-pack” 110 is comprised of right side reflector panel 104 elements 112 and 122, center reflector panel 106 elements 111 and 121, and left side reflector panel 108 elements 114 and 124. Subsequent “six-packs” 120, 130, 140 and 150 are positioned sequentially below each other as shown in FIG. 1.

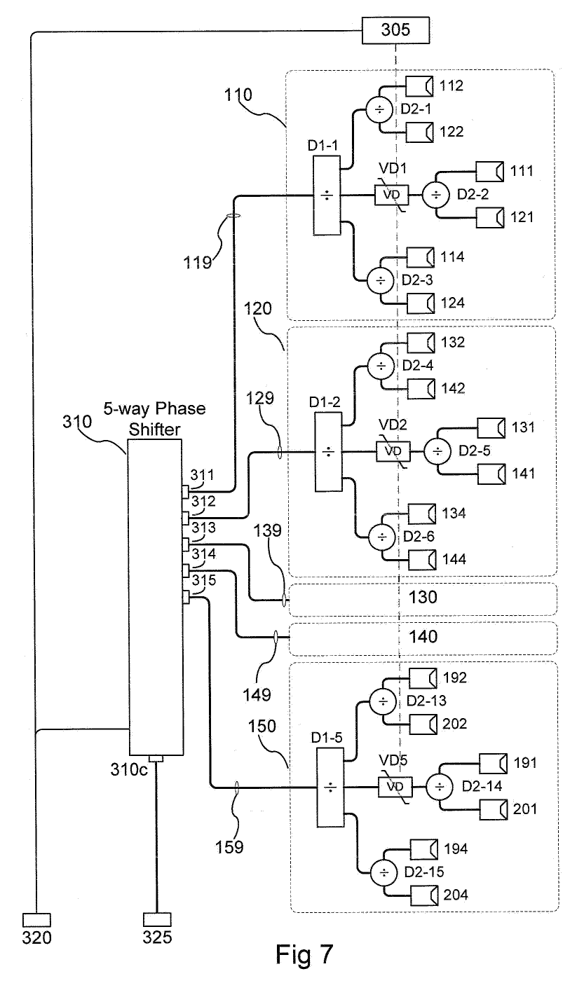

With further reference to FIGS. 6 and 7 each “six-pack”, for example the top most “six-pack” 110, in addition to six radiating elements (112, 122, 111, 121, 114, and 124) includes three conventional RF signal dividers D2-1, D2-2, D2-3, variable delay network VD1, and a frequency compensated, 3-way signal divider D1-1 network. The following description is equally applicable to all “six-pack” groups. RF signal dividers D2-1, D2-2, D2-3 can utilize any suitable power, in phase signal combining-dividing network—for example a Wilkinson combiner. The left pair of radiating elements (112 and 122) are coupled to the first combining-dividing network D2-1. The first combining-dividing network D2-1 common port is coupled to the first output (D1-1, L) port of the three way, frequency compensated combiner-divider D1-1. Similarly, the right pair of radiating elements (114 and 124) are coupled to the third combining-dividing network D2-3. The third combining-dividing network D2-3 common port is coupled to the third output R port of the three way, frequency compensated combiner-divider D1-1. Depending on the direction of signal flow the divider can be used as a combiner in a manner known to those skilled in the art. Three-way, frequency compensated combiner-divider D1-1 also provides frequency compensation in phase and amplitude which reduces azimuth HPBW variation over a wide bandwidth of operating frequencies.

The variable delay line VD1-1 can be constructed using electromechanically actuated design. The variable delay VD1 line actuator is coupled to a center panel 106 displacement means 305 that provides Z-dimension displacement for center reflector panel 106. Hence, all variable delay lines (VD1-5) have their corresponding actuators coupled to a center panel displacement 305 actuator. The variable delay line, VD1, has its input port coupled to center port (S) of the three way, frequency compensated combiner-divider D1-1. The three way, frequency compensated D1-1 signal combining-dividing network has its common port C coupled to a corresponding (RF I/O) distribution port 311 of the 5 way phase 310 shifter. Variable delay VD1-5 lines reduce the mechanical displacement ±D needed to achieve a full range of azimuth HPBW settings. Variable delay VD1-5 lines can be omitted (see FIG. 6), at a cost of having center reflector panel 106 moved over extended distance, which requires use of flexible coaxial cable.

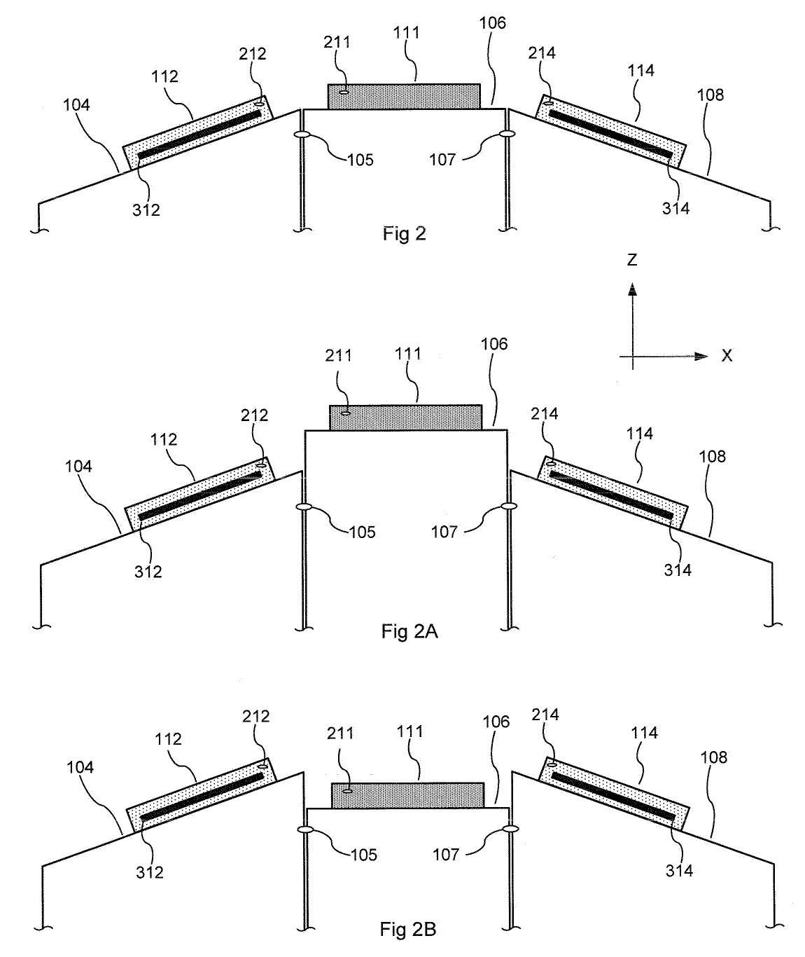

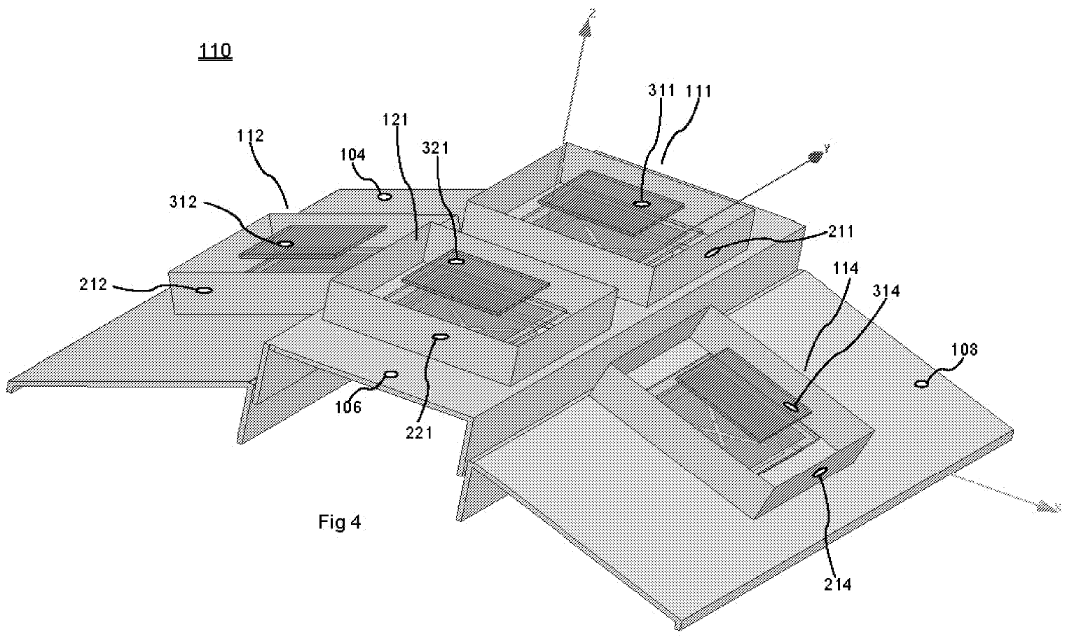

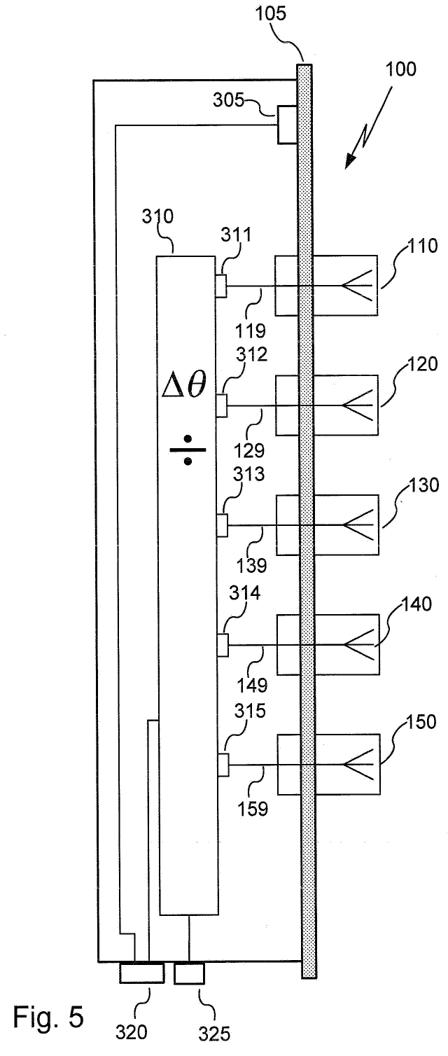

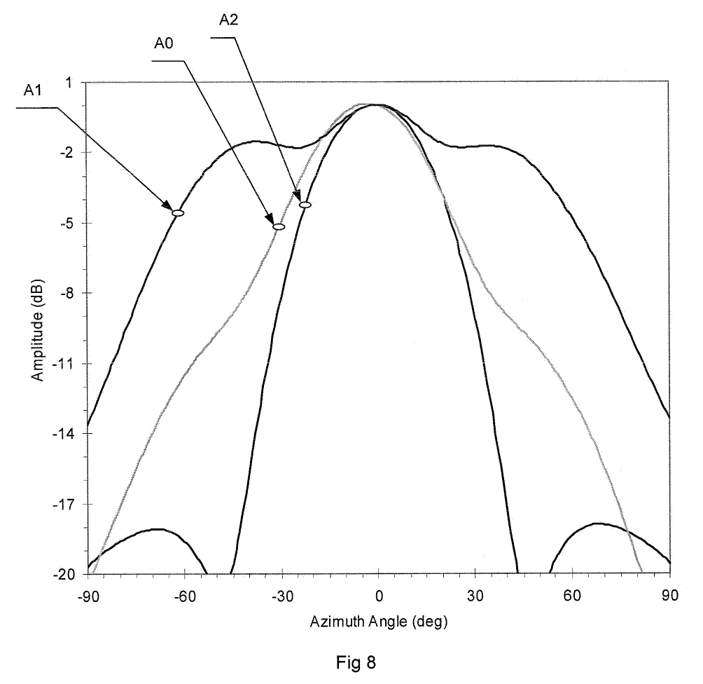

With reference to FIG. 2, 2A and 2B azimuth beam width control will now be described. Half power beam width (HPBW) in azimuth plane in the present of antenna 100 can be controlled by altering the Z-dimension position of center 106 reflector panel relative to right 104 and left 108 reflector panels (FIG. 4). The right 104 and left 108 reflector panels are rigidly attached to the antenna back stay while center reflector 106 panel is coupled to suitably constructed remotely controllable actuator 305. Azimuth HPBW alteration is achieved through controlled displacement of center reflector 106 panel. FIG. 2 shows center panel 106 with its plane edge being flush with right 104 and left 108 reflector panel edges. Such position corresponds to 41 degree HPBW azimuth angle and radiation pattern shown in FIG. 8, curve A0. In order to increase HPBW angle the center reflector panel 106 is moved outwards as shown in FIG. 2A. This is achieved by commanding remotely controllable actuator 305 to provide necessary displacement for wide, for example 105 degrees, HPBW azimuth angle configuration with a radiation pattern as shown in FIG. 8, curve A1. Conversely, for a narrower HPBW azimuth angle, center reflector 106 panel is moved inward, below the high edges formed by right 104 and left 108 reflector panels. An example of a narrow HPBW azimuth angle configuration, 36 degrees, is shown by the radiation pattern in FIG. 8, curve A2.

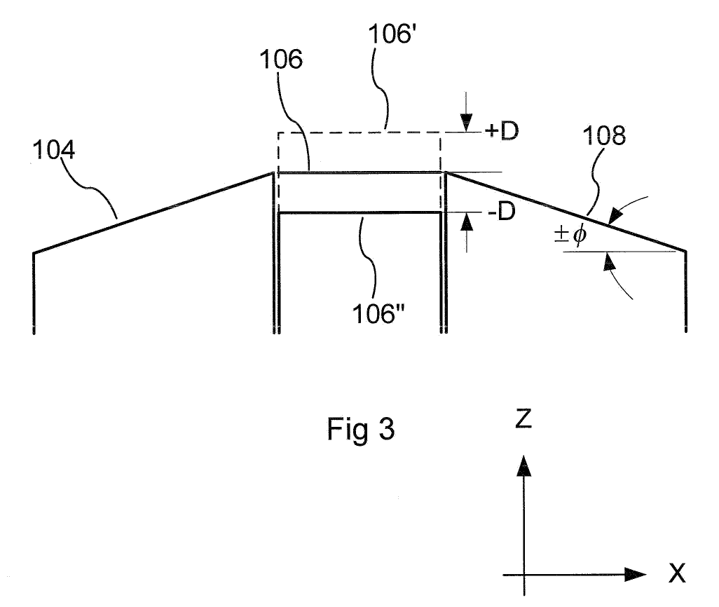

As described above center panel displacement is controlled by a mechanical actuator 305 which allows for Z-dimension movement of the center panel 106 over predetermined displacement ±D. Displacement dimensions can be controlled by a remote programmable controller or by providing local mechanical overriding means as may be required during antenna commissioning or on the fly, during actual in service operation. It is possible for +D and −D limits to have different values. For example, +D can have a value=25 mm, while −D can have value −20 mm as shown in FIG. 3.

The present invention has been described primarily in solving the aforementioned problems relating to use of plurality of mechanical phase shifters, however, it should be expressly understood that the present invention may be applicable in other applications wherein azimuth beamwidth control is required or desired. In this regard, the foregoing description of a triple pole antenna array, equipped with displaceable center reflector plane, is presented for purposes of illustration and description only. Furthermore, the description is not intended to limit the invention to the form disclosed herein. Accordingly, variants and modifications consistent with the following teachings, and skill and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. An antenna for a wireless network, comprising:
first, second and third reflectors each having one or more radiators coupled thereto, the second reflector configured adjacent to and between the first and third reflectors;
wherein the second reflector is generally planar and movable relative to the first and third reflectors in a direction generally perpendicular to the planar surface of the second reflector.

2. The antenna of claim 1, wherein said first and third reflectors are fixed.

3. The antenna of claim 1, wherein the first and third reflectors are generally planar and are configured with their planar surfaces oriented at different angles relative to that of the second reflector.

4. The antenna of claim 1, wherein the second reflector is movable from a first configuration where the surface thereof is generally contiguous with the adjacent surfaces of the first and third reflectors to a second configuration where the surface thereof is above the adjacent surfaces of the first and third reflectors.

5. The antenna of claim 4, wherein the second reflector is movable to a third configuration wherein said surface thereof is configured below the adjacent surfaces of the first and third reflectors.

6. The antenna of claim 5, wherein the second reflector has a generally planar surface defined by a Y-axis and an X-axis parallel to the plane of the reflector surface and a Z-axis extending out of the plane of the reflector, and wherein the second reflector is movable in the Z direction.

7. The antenna of claim 6, wherein the first and second reflectors, and second and third reflectors have adjacent edge portions and wherein in said first configuration respective adjacent edge portions are aligned.

8. The antenna of claim 7, wherein the second reflector is offset in said Z direction from adjacent edge portions of the first and third reflectors by a first positive distance in said second configuration and by a second negative distance in said third configuration.

9. The antenna of claim 8, wherein said first distance is about +25 mm and said second distance is about −20 mm.

10. The antenna of claim 1, further comprising an actuator coupled to said second reflector.

11. The antenna of claim 6, wherein the radiators coupled to said first and third reflectors are offset in said Y direction from the radiators coupled to said second reflector.

12. A mechanically variable beam width antenna, comprising:
a reflector structure having plural reflector panels with respective generally planar panel surfaces oriented in different directions, the plural reflector panels including a center panel and first and second outer panels;
a first plurality of radiators coupled to the first outer panel and configured in a first column;
a second plurality of radiators coupled to the second outer panel and configured in a second column;
a third plurality of radiators coupled to the center panel and configured in a third column;
at least one actuator coupled to the center panel;
wherein the center reflector panel is movable relative to the other panels from a first configuration wherein adjacent edge portions of the panel surfaces are contiguous to a second configuration where the center panel surface is spaced above or below the adjacent edge portions of the outer panels.

13. The antenna of claim 12, further comprising a multipurpose port coupled to the at least one actuator to provide beam width control signals to the antenna.

14. The antenna of claim 12, further comprising a signal combining-dividing network for providing RF signals to the first, second and third plurality of radiators wherein the signal combining-dividing network includes a phase shifting network for controlling elevation beam tilt by controlling relative phase of the RF signals applied to the radiators.

15. The antenna of claim 14, wherein the first, second and third plurality of radiators are coupled to separate phase shifting networks in groups.

16. The antenna of claim 15, wherein the radiators are coupled to separate phase shifting networks in plural groups of six radiators, each group corresponding to two radiators for each reflector panel.

17. The antenna of claim 12, wherein the first and second plurality of radiators are configured in rows aligned perpendicularly to said columns and the third plurality of radiators are offset from the rows of said first and second plurality of radiators.

18. The antenna of claim 12, wherein the radiators comprise aperture coupling patch radiating elements.

19. A method of adjusting signal beam width in a wireless antenna having a plurality of radiators configured on at least three separate reflector panels including two outer panels and a center panel, wherein at least the center panel is movable in a direction generally perpendicular to a plane of the reflector panel, the method comprising:
providing the reflector panels in a first configuration where adjacent panel edge portions are aligned to provide a first signal beam width; and
moving the center panel in a direction generally perpendicular to the surface of the panel to a second configuration wherein the center panel is spaced apart in a direction generally perpendicular to the panel surface from the adjacent panel edge portions of the outer panels to provide a second signal beam width.

20. The method of claim 19, wherein the outer panels are fixed.

21. The method of claim 19, further comprising providing at least one beam width control signal for remotely controlling the position setting of the center panel.

22. The method of claim 19, further comprising providing variable beam tilt by controlling the phase of the RF signals applied to the radiators through a remotely controllable phase shifting network.

23. The method of claim 22, wherein the network is coupled to separate groups of radiators.

24. The method of claim 19, wherein the outer panels are configured with panel surfaces oriented at an angle relative to the center panel.

25. The method of claim 19, wherein plural radiators are configured on each reflector panel.
